(19) United States
(12) Patent Application Publication
(10) Pub. No.: US 2014/0101059 A1
(43) Pub. Date: Apr. 10, 2014

(54) LEASING METHOD FOR LESSEES TO EXCHANGE THEIR SHIPPING CONTAINERS

(71) Applicant: Chien-Hua HSIAO, Taoyuan County (TW)

(72) Inventor: Chien-Hua HSIAO, Taoyuan County (TW)

(21) Appl. No.: 13/645,973

(22) Filed: Oct. 5, 2012

(51) Int. Cl. G06Q 10/00

(52) U.S. Cl. 705/307

(57) ABSTRACT

A leasing method, which allows lessees to exchange their shipping containers includes: inputting exchange data of the shipping containers for exchange. The exchange data includes the location of the shipping container for exchange-out, the location of the shipping container for exchange-in, and the container specifications. The system automatically search in the database for the matched shipping container and inform the lessees that they can exchange their shipping containers. Next, the lessees respectively lease the shipping containers after exchange.

### BACKGROUND OF THE INVENTION

1. Field of the Invention

The present invention relates generally to transportation of shipping containers, and more particularly to a leasing method for lessees to exchange their leased shipping containers.

2. Description of the Related Art

Goods usually transport within and between countries by different transportation such as trucks, trains, ships or airplanes.

Today, goods would transit among nations by shipping if the quantity of goods were enormous. The demand and supply of the shipping container in different harbors depends on different marine transport corporation's operational planning or business situation. Moreover, the costs of transporting are also different between marine transport corporations due to these corporations have different route plans.

Marine transport corporations have to balance the demand and supply in each harbor, and the most common solution is by moving the extra shipping containers from one harbor to the other harbor which is in need of them. However, this solution would incur additional costs for these marine transport corporations each year. Another reason for the increasing costs is the barge services which are provide by other companies to be the supplement of marine transport companies' route plans. Moreover, even in the same place, each transport corporations or shipping container lessees may have different costs for transportation because they have different marketing strategies or related plans.

A marine transport companies would have two kinds of shipping container. One is the container which is bought by the companies, another kind is the container that rent from other corporation. For the maximum rate of return on investment, marine transport corporations would hope the usage of these rental containers can be increased, but these rental containers usually are been transported among harbors to balance the demand and supply instead of using by corporations. Consequently, the return on investment decrease and the costs of the transportation increase.

In order to reduce the removal costs, the container lessees would release the empty containers for others to use with no charge until they arrive in the harbor where the containers is needed. Although this way can bring down the costs, the usage rate of the container still can't be improved. Moreover, the container lessees have to pay a lot of attention to monitor the actual usage and the demand and supply may not be match at the same location.

Not only can't lower the costs, the relationship between lessor, lessee and the third party, who use the released container, become complicated. If the lessee wants to transfer the lease to the third party, they would enter a time consuming process. First, the lessor would evaluate the business relationship with the third party and his or her credit status. Then, the third party and the lessor would have to discuss the contract. In other words, the lease condition would not be the same as the lessee.

### SUMMARY OF THE INVENTION

The primary objective of the present invention is to provide an impact power tool, which is able to precisely control the torque output and shorten the turning time in the low torque level.

According to the objective of the present invention, the present invention provides a leasing method for lessees to exchange shipping containers, in which a plurality of lessees respectively lease the shipping container from a lessor. The leasing method includes the steps of:

A. inputting exchange data at a client end, and transmitting the exchange data to a serve end through a network, wherein the exchange data include a container specification of a shipping container for exchange-out and a location of the shipping container;

B. Comparing the exchange data to find a shipping container which is leased by another lessee and is able to exchange, wherein the shipping container which is able to exchange meets an exchange condition; and

C. Exchanging the shipping containers which meet the exchange condition, whereby the lessees respectively lease the shipping containers after exchange.

In an embodiment, the server end has a database to store distribution information of the lessees at each location, and the leasing method further comprising the steps of comparing the distribution information to find the shipping containers which are able to exchange before the step A, and showing the shipping containers which are able to exchange at the client end.

In an embodiment, the distribution information includes the locations of the lessee having the unnecessary empty shipping container and the locations of the lessee facing a shortage of the empty shipping container, and the locations of the lessee having the unnecessary empty shipping container is compared with the locations of the other lessees facing a shortage of the empty shipping container and the locations of the lessee facing a shortage of the empty shipping container is compared with the locations of the other lessees having the unnecessary empty shipping container to find the shipping containers, which are able to exchange.

In an embodiment, the distribution information includes transport fees of the lessees at the different locations, and the transport fees of the lessees at the same location are compared to find the shipping containers, which are able to exchange.

In an embodiment, the container specification includes container number, container size, container condition, and manufacture date.

In an embodiment, the container specification of the shipping containers are pre-stored in a database at the server end, and the server end automatically search in the database for the container size and the manufacture date of the shipping container when the lessee input the container number in the step A.

In an embodiment, the container condition indicates that the shipping container passes Institute of International Container Lessors (IICL) standard.

In an embodiment, the container condition indicates that the shipping container passes Cargo Worthy standard.

In an embodiment, the exchange condition includes the container sizes of the shipping containers being the same, the container conditions of the shipping containers passing a standard, and the manufacture dates of the shipping containers within a predetermined period.

In an embodiment, the manufacture dates of the shipping containers are in the same year.

In an embodiment, the manufacture dates of the shipping containers are within a year.

In an embodiment, the manufacture dates of the shipping containers are within half year.

In an embodiment, the lessees who exchange the shipping containers respectively return the shipping container for exchange to the lessor, and then make a new leasing contract with the lessor to lease the shipping containers after exchange.

In an embodiment, the lessees who exchange the shipping containers respectively change a content of an original leasing contract with the lessor to lease the shipping containers after exchange.

In an embodiment, except for leasing the shipping containers after exchange the rest content of the leasing contract is kept the same.

In an embodiment, a leasing price, a leasing period, a location of returning the shipping container, a ratio of depreciation, a maximum depreciation, and a salvage value in the leasing contract are kept the same.

In an embodiment, the exchange data further include a location of a shipping container for exchange-in, wherein the exchange condition further includes the location of the shipping container for exchange-in being identical to the location of the shipping container for exchange-out of the other lessees.

Therefore, the present method of the present invention may raise the usage rate of the shipping containers and reduce the cost of transportation. The method is not only applied to the lessees who respectively has unnecessary empty shipping containers and faces a shortage of shipping container but also applied to the other business issues to allow the lessee to exchange their shipping containers for cost down. To the container lessor, he/she only has to change some container specification in the old contract rather than making a new contract with the lessee.

### BRIEF DESCRIPTION OF THE DRAWINGS

FIG. 1 is a flow chart of the leasing method of a preferred embodiment of the present invention;

FIG. 2 and FIG. 3 are sketch diagrams of the leasing method of the preferred embodiment of the present invention, showing the empty shipping containers of the lessees before and after exchange;

FIG. 4 and FIG. 5 are sketch diagrams of the leasing method of the preferred embodiment of the present invention, showing the shipping containers which belong to each lessees before and after exchange; and

FIG. 6 and FIG. 7 are sketch diagrams of the leasing method of another preferred embodiment of the present invention, showing the shipping containers of the lessees before and after exchange.

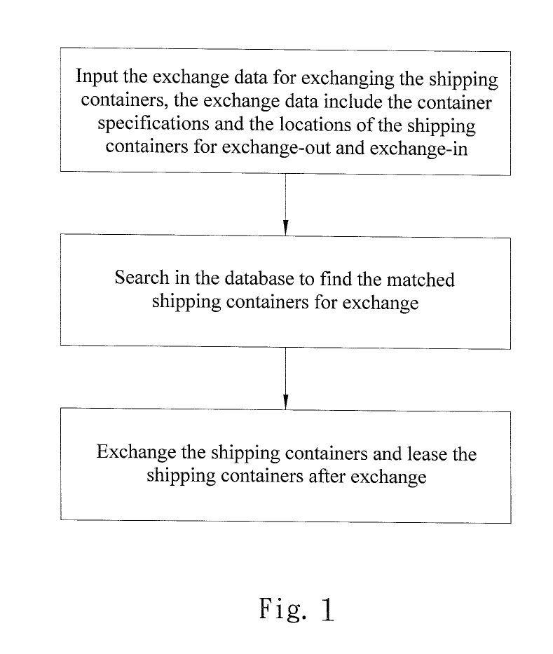

### DETAILED DESCRIPTION OF THE INVENTION

The detailed description and technical contents of the present invention will be explained with reference to the accompanying drawings. However, the drawings are illustrative only but not used to limit the present invention.

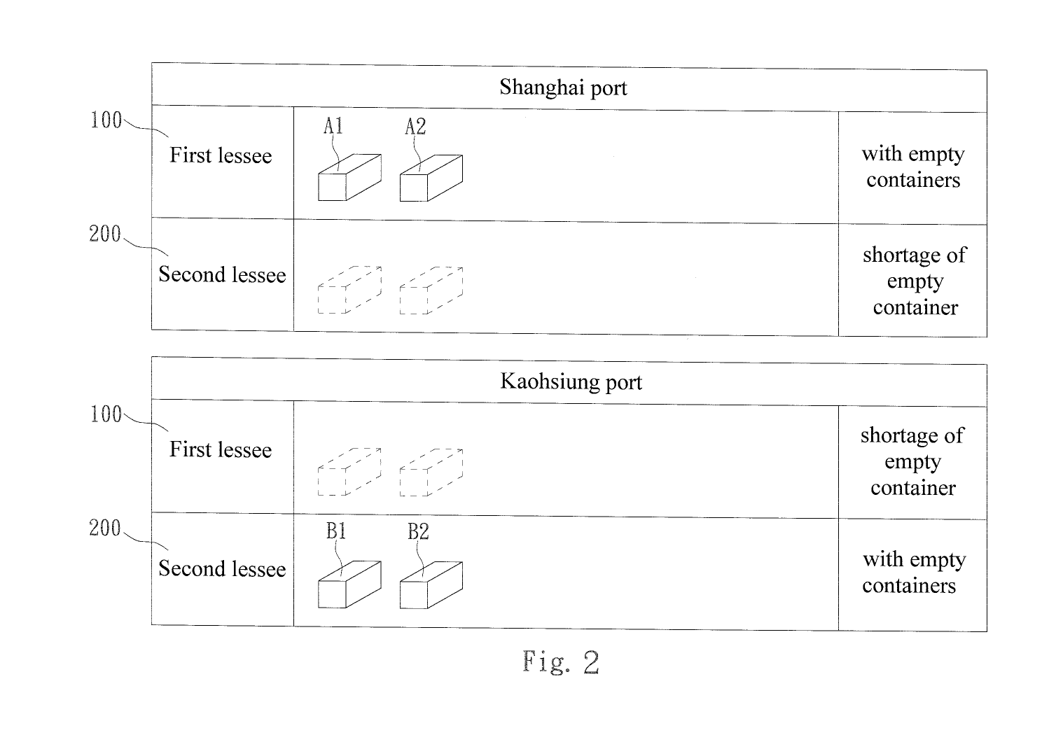

A method of the present invention is applied to a plurality of lessees who have leased shipping containers from a lessor (container lessor). The method is performed between a serve end and a plurality of client ends through a network, such as internet. The serve end has a database, in which container specifications of the shipping containers are stored. The container specification including container number, container size, and manufacture date. For example, as shown in FIG. 2, there are two lessees who have leased containers from the container lessor, and one of the lessees, the first lessee 100, has several unnecessary empty containers A1, A2 at Shanghai port and faces a shortage of empty containers at Kaohsiung port and, on the contrary, the other lessee, the second lessee 200, has several unnecessary empty containers B1, B2 at Kaohsiung port and faces a shortage of empty containers at Shanghai port. These two lessees 100, 200 may use the method of the present invention to solve their problems.

The method includes the following steps:

A. Provide an interface for the lessees 100, 200 to input the exchange data of the shipping containers which are available for exchange A1, A2, B1, B2, including the location of the container for exchange-out, and the location of the container for exchange-in. In an embodiment, the exchange data further include container number, container size, container condition, and manufacture date. The definition of the container condition is based on the Institute of International Container Lessors (IICL) standard or Cargo Worthy standard. In an embodiment, the lessee only needs to input the container's number and condition, and the server end will automatically search in the database for the specification and manufacture date of the container.

In practice, the first lessee 100 inputs the exchange data of the shipping containers which are available for exchange A1, A2 (the place for exchange-out is Shanghai port, and the place for exchange-in is Kaohsiung port) through a computer which connects to internet, and the second lessee 200 inputs the exchange data of the containers which are available for exchange B1, B2 (the place for exchange-out is Kaohsiung port, and the place for exchange-out is Shanghai port) through a computer which connects to internet, and their exchange data will be transmitted to database of the server end and stored.

B. Compare the exchange data at the server end. In an embodiment, the shipping containers which are able to exchange must match an exchange condition. The exchange condition includes the container sizes are the same, the container condition passes the standard, the places for exchange-out and exchange-in are identical to the place for exchange-in and exchange-out of the other shipping container, and the manufacture dates are the same or within a predetermined period (such as a year or half year).

In this step, the serve end will find the possibility for the lessees to exchange their shipping containers according to their exchange data without some problems, such as exchange a new shipping container for an old one, or a good shipping container for a bad one. In the present embodiment, the server end will respectively inform the first and the second lessees 100, 200 that their shipping containers A1, A2, B1, B2 are able to exchange.

C. The first lessee 100 leases the shipping containers B1, B2 which are leased by the second lessee 200, and the second lessee 200 leases the shipping containers A1, A2 which are leased by the first lessee 100. In an embodiment, the first and the second lessees 100, 200 respectively makes a leasing contract with the container lessor that the first/second lessee 100/200 agrees to lease the shipping containers B1, B2/A1, A2 which were leased by the second/first lessee 200/100 with the same content of the original leasing contract. The leasing contact's content includes the leasing price, the leasing period, the location of returning the container, the ratio of depreciation, the maximum depreciation, the salvage value, and other common content in an ordinary contract of leasing the shipping container.

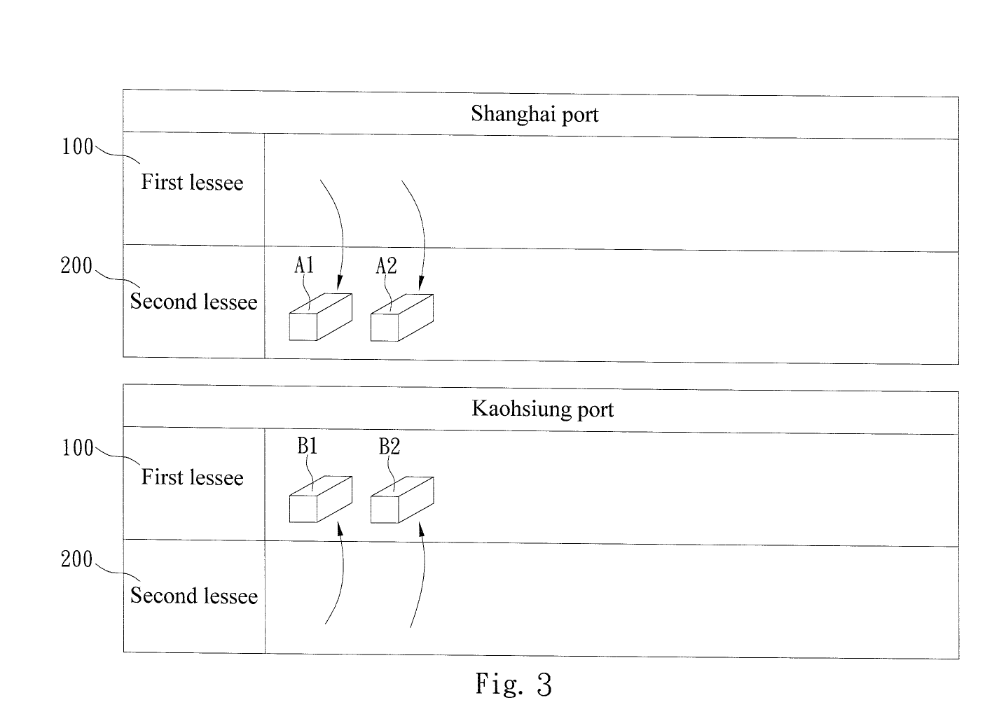

In this step, as shown in FIG. 3, the shipping containers A1, A2 at Shanghai port are leased by the second lessee 200, and the shipping containers B1, B2 at Kaohsiung port are leased by the first lessee 100.

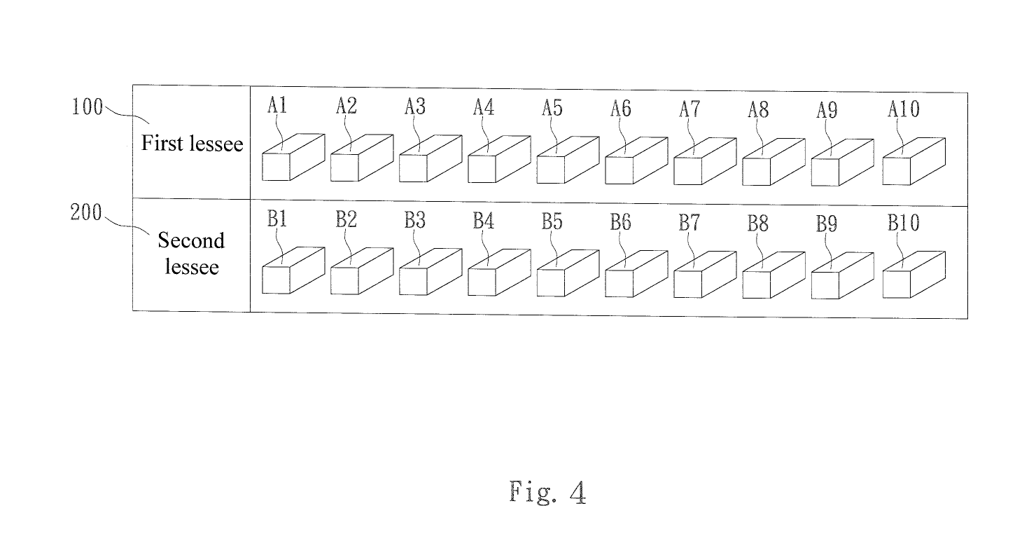

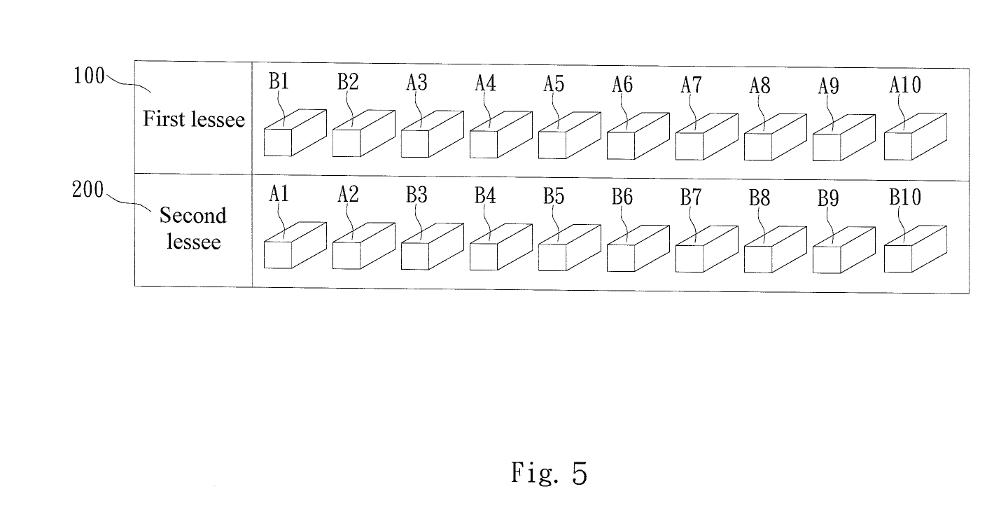

As shown in FIG. 4, suppose the first lessee 100 leased ten shipping containers A1-A10 from the container lessor and the second lessee 200 leased ten shipping containers B1-B10 from the container lessor. They use the leasing method of the present invention to exchange their shipping containers. After exchange, the first lessee 100 still leases ten shipping containers in the new leasing contract, including eight old shipping containers A3-A10 and two new-leased shipping containers B1, B2, which are exchanged from the second lessee 200, and the second lessee 200 still leases ten shipping containers, including eight old shipping containers B3-B10 and two new-leased shipping containers A1, A2 which are exchanged from the first lessee 100. Therefore, the new leasing contract basically is the same as the original leasing contract, including leasing price, number of the leased shipping containers, and the returning location . . . , except some shipping containers have different container specifications. Through the leasing method of the present invention, the lessee does not need to ship their unnecessary empty shipping container from one port to another. It allows the lessee to release his/her unnecessary empty shipping containers to another lessee who needs empty shipping containers at the same port.

With the leasing method of the present invention, the lessee may save the cost to transport the empty shipping containers from one port to another which usually is an overseas port, and raise the usage rate of the shipping containers. To the container lessor, the method of the present invention provides the lessees to exchange their leased shipping containers with the same contract, so that the container lessor only has to change some container specification in the old contract rather than make a new contract with the lessee. Therefore, the lessees may have a high rate of investment return, and the container lessor may get more leasing contracts because the lessees is more willing to lease more shipping containers from the container lessor.

The database of the server end may store distribution information of each lessee at each port so that the server end may compare the distribution information of the other lessees to find the shipping containers which are available for exchange-in or exchange-out at each port, and show the result on the computer of the lessee before he/she inputs the container specification to speed up the exchange service.

For example the distribution information includes in which port the lessee has unnecessary empty shipping containers, in which port the lessee faces a shortage of empty shipping container, and transport fee of the shipping containers at each port. Therefore, the server end may have a pre-comparison between the ports of having unnecessary empty shipping containers, the port of shortage of empty shipping container, and the transport fees at the ports, and then the computer may show the information, including the places and the lessees, which are able to exchange the shipping containers, to speed up the exchange service. The description of the leasing method of the present invention only teaches the method of exchange between two lessees, and it is easy to understand that the leasing method may be applied to three, four or more lessees to exchange their shipping containers.

The leasing method of the present invention also may allow the lessees to return their shipping containers for exchange to the lessor, and then make a new contract with the lessor to lease the shipping containers which are exchanged from another lessee.

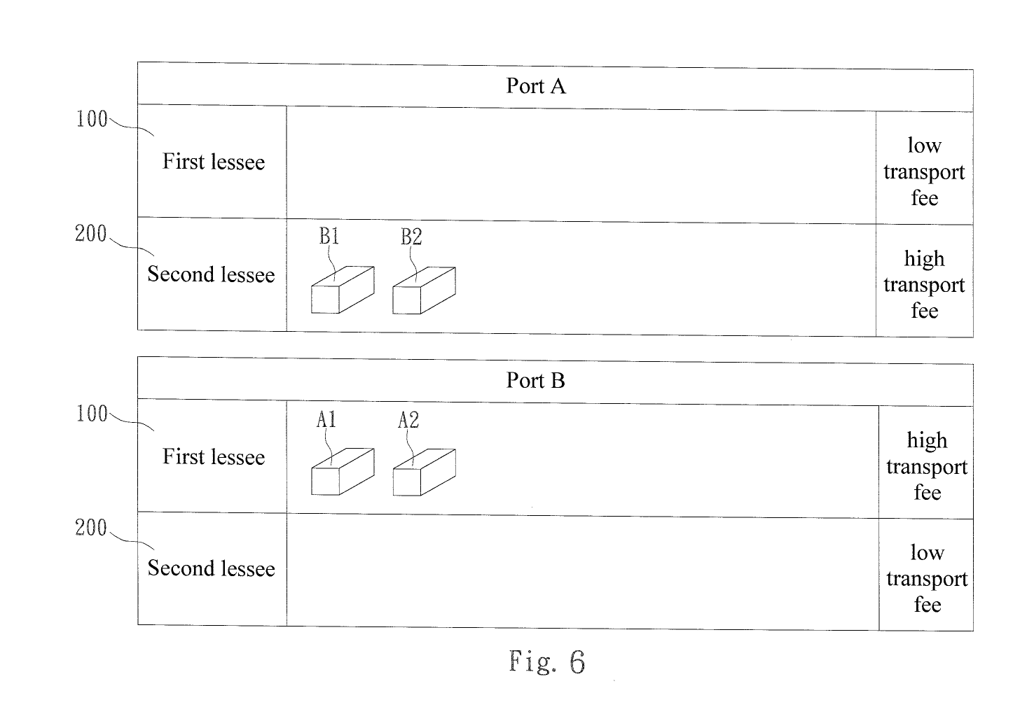

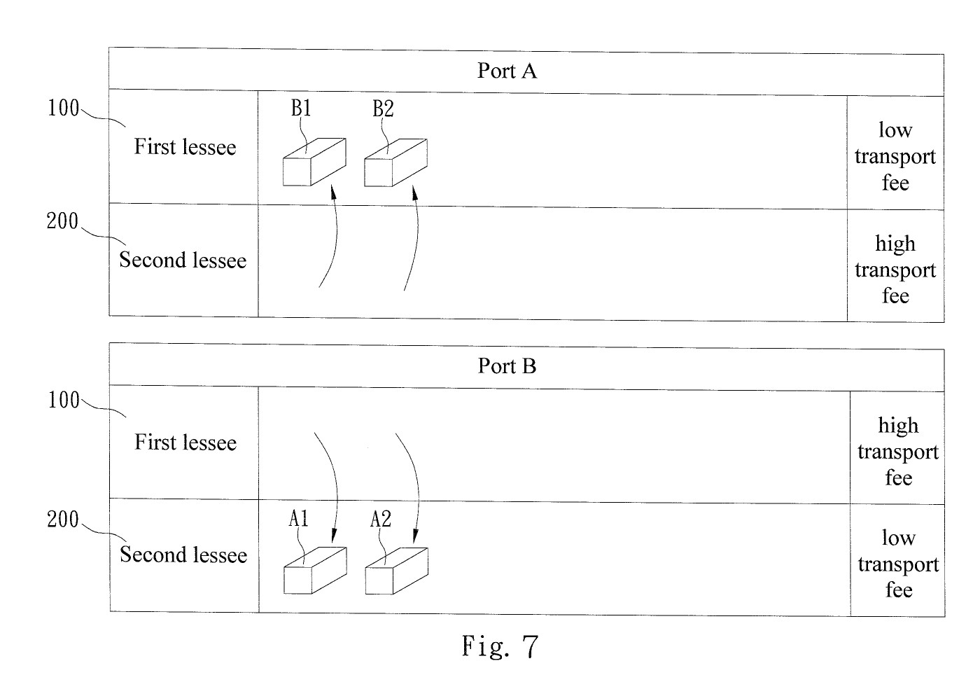

The leasing method of the present invention also may be applied under the consideration of transport fee of the shipping container or other business issues. As shown in FIG. 6 and FIG. 7, the leasing method of the present invention also may be applied between a port which has unnecessary empty shipping containers and a port which faces a shortage of empty shipping container. For example, the first lessee 100 has a lower transport fee at the port A than at the port B and has unnecessary empty shipping containers at the port B, and on the contrary, the second lessee 200 has a higher transport fee at the port A than at the port B and has unnecessary empty shipping containers at the port A. They may exchange their empty shipping containers through the leasing method of the present invention to save the transport fee.

The description above only teaches the exchange between two or more lessees. However, the leasing method of the present invention allows the same lessee to exchange the shipping containers which belongs to different leasing contracts. The description above is a few preferred embodiments of the present invention, and the equivalence of the present invention is still in the scope of claim construction of the present invention.

What is claimed is:

1. A leasing method for lessees to exchange shipping containers, wherein a plurality of lessees respectively lease the shipping container from a lessor, the leasing method comprising the steps of:
A. inputting exchange data at a client end, and transmitting the exchange data to a serve end through a network, wherein the exchange data include a container specification of a shipping container for exchange-out and a location of the shipping container;
B. Comparing the exchange data to find a shipping container which is leased by another lessee and is able to exchange, wherein the shipping container, which is able to exchange, meets an exchange condition; and
C. Exchanging the shipping containers which meet the exchange condition, whereby the lessees respectively lease the shipping containers after exchange.

2. The leasing method as defined in claim 1, wherein the server end has a database to store distribution information of the lessees at each location, and the leasing method further comprising the steps of comparing the distribution information to find the shipping containers which are able to exchange before the step A, and showing the shipping containers which are able to exchange at the client end.

3. The leasing method as defined in claim 2, wherein the distribution information includes the locations of the lessee who has the unnecessary empty shipping container and the locations of the lessee who faces a shortage of the empty shipping container, and the locations of the lessee who has the unnecessary empty shipping container is compared with the locations of the other lessees who face a shortage of the empty shipping container, and the locations of the lessee who faces a shortage of the empty shipping container is compared with the locations of the other lessees who have the unnecessary empty shipping container to find the shipping containers which are able to exchange.

4. The leasing method as defined in claim 2, wherein the distribution information includes transport fees from the lessees at the different locations, and the transport fees from the lessees at the same location are compared to find the shipping containers, which are able to exchange.

5. The leasing method as defined in claim 1, wherein the container specification includes container number, container size, container condition, and manufacture date.

6. The leasing method as defined in claim 5, wherein the container specification of the shipping containers are pre-stored in a database at the server end, and the server end automatically search in the database for the container size and the manufacture date of the shipping container when the lessee input the container number in the step A.

7. The leasing method as defined in claim 5, wherein the container condition indicates that the shipping container passes Institute of International Container Lessors (IICL) standard.

8. The leasing method as defined in claim 5, wherein the container condition indicates that the shipping container passes Cargo Worthy standard.

9. The leasing method as defined in claim 5, wherein the exchange condition includes the container size of the shipping containers being the same, the container condition of the shipping containers passing a standard, and the manufacture date of the shipping containers within a predetermined period.

10. The leasing method as defined in claim 9, wherein the manufacture dates of the shipping containers are in the same year.

11. The leasing method as defined in claim 9, wherein the manufacture dates of the shipping containers are within a year.

12. The leasing method as defined in claim 9, wherein the manufacture dates of the shipping containers are within half year.

13. The leasing method as defined in claim 1, wherein the lessees who exchange the shipping containers respectively return the shipping container for exchange to the lessor, and then make a new leasing contract with the lessor to lease the shipping containers after exchange.

14. The leasing method as defined in claim 1, wherein the lessees respectively change a content of an original leasing contract with the lessor to lease the shipping containers after exchange.

15. The leasing method as defined in claim 1, wherein except for leasing the shipping containers after exchange the rest content of the leasing contract is kept the same.

16. The leasing method as defined in claim 15, wherein the content leasing contract is selected from at least one of the group consisting of a leasing price, a leasing period, a location of returning the shipping container, a ratio of depreciation, a maximum depreciation, and a salvage value.

17. The leasing method as defined in claim 1, wherein the exchange data further include a location of a shipping container for exchange-in, wherein the exchange condition further includes the location of the shipping container for exchange-in being identical to the location of the shipping container for exchange-out of the other lessees.
